(19) United States
(12) Patent Application Publication
(10) Pub. No.: US 2022/0069314 A1
(43) Pub. Date: Mar. 3, 2022

(54) BATTERY CELL, VEHICLE BATTERY, MOTOR VEHICLE AND METHOD FOR PRODUCING A CARRIER ELEMENT FOR AN ELECTRODE OF A BATTERY CELL

(71) Applicant: AUDI AG, Ingolstadt (DE)

(72) Inventors: Christian Gert VOIGT, Usingen (DE); Peter PILGRAM, Neuburg an der Donau (DE)

(73) Assignee: AUDI AG, Ingolstadt (DE)

(21) Appl. No.: 17/389,956

(22) Filed: Jul. 30, 2021

(30) Foreign Application Priority Data
Aug. 26, 2020 (DE) 10 2020 122 287.4

(51) Int. Cl. H01M 4/75; H01M 10/0525; H01M 50/46; H01M 4/66

(52) U.S. Cl. CPC H01M 4/75; H01M 10/0525; H01M 4/663; H01M 4/661; H01M 50/46

(57) ABSTRACT

A battery cell with at least one electrode which has a carrier element and an active layer abutting the carrier element and with an electrode material for the alternating uptake and release of ions, the carrier element electrically connecting the active layer with an electric connecting pole of the battery cell, and having an electrically conductive surface for said exchanging of electrons with the electrode material of the active layer. The electrically conductive surface of the respective carrier element is provided by electrical conducting elements, the conducting elements being provided by fibers and/or granules and/or a slotted and/or perforated film and/or film strip and/or a wad.

### FIELD

The disclosure relates to a battery cell with at least one electrode, wherein an active layer with an electrode material for the alternating uptake and release of ions abuts the carrier element. Another designation for such a carrier element is simply “carrier”. Active material is an alternative designation for the electrode material. To the disclosure includes also a vehicle battery with at least one battery cell of the type described and a motor vehicle with such a vehicle battery. Finally, the disclosure also comprises a method for producing said carrier element.

### BACKGROUND

In a vehicle battery, a plurality of battery cells can be interconnected by means of series circuit and/or parallel circuit in such a way that the vehicle battery can provide a predetermined nominal voltage and a predetermined nominal current. Such a vehicle battery can be configured, for example, as a high-voltage battery providing a nominal voltage greater than 60 volts, particularly greater than 100 volts. In this case, each battery cell thus represents a galvanic cell, i.e., it comprises electrodes coupled for an ion exchange via an electrolyte. The electrodes are usually separated by a so-called separator in order to prevent electrons from crossing over.

Each electrode is electrically connected in each case with one of the electric connecting poles of the battery cell (positive pole or negative pole). For this purpose, the electrode may have a carrier element or contacting element, which, for example, can be formed of a metal, for example copper or aluminum. An active layer made of said electrode material or active material may be arranged on the carrier element, which material is configured for the actual taking up and releasing of the ions. An example of such an active material is graphite or carbon.

In the high-voltage batteries of electrically operated vehicles, lithium-ion battery cells are currently predominantly used in various packaging forms such as round cells, prismatic cells or pouch cells. Important basic parameters of the battery cells are the cell capacity, the energy density and power. In addition to the cell chemistry used and the coating methods, the number of layers of anode, cathode and separator to be accommodated, is a direct quantity impacting the cell capacity, energy density and power density. Other cell types, e.g., in low-voltage applications and consumer products, are also within the scope of this rule.

The active surface of a film of an electrode of the battery cell results from length×width×2 (top and bottom sides). It follows from this that, with a given volume or installation space, the active surface area can be enlarged by using thinner films and a higher number of layers/number of windings then possible. The minimization of the film thickness is however limited by the need for mechanical strength, which otherwise would limit the production rate; the need for current carrying capacity, which otherwise would lead to increased self-heating and accelerated aging; the need for heat dissipation, which otherwise would also lead to accelerated aging. The film thickness currently used in industry is between 6 μm and 20 μm. As a result of the above factors, the further reduction in the film thickness reaches its technological limits. In terms of film technology, this means a technological limit in terms of cell capacity, energy density and power density.

In DE 10 2010 011 413 A1 it is described that the support of a respective electrode of a battery cell is configured preferably as a sheet, thin plate or collector film.

DE 10 2009 035 490 A1 discloses the use of a separator for a Li-ion cell, which separator is based on a nonwoven fabric. A battery cell with separators based on nonwoven fabric is also known from EP 2 830 125 B1.

The carrier element serves to transfer electrons from the active layer toward the connecting pole of the battery cell, or vice versa from a connecting pole of the battery cell toward the active layer. The interface between the active layer and the carrier element, that is, on the surface of the carrier element, this results in a current density, which, inter alia, is a function of the thickness and/or capacity of the active layer, since this determines the number of exchangeable ions per square millimeter. Therefore, it may be that with a more powerful active layer, the current density at the surface of a carrier element can be so high that the contact resistance between the active layer and the carrier element affects the performance of the battery cell.

### SUMMARY

It is the object of the disclosure to provide, in case of a battery cell, an efficient electrical connection of the active layer of at least one of the electrodes to the respective connecting pole of the battery cell.

The object is achieved by the subject matter of the independent claims. Advantageous embodiments of the disclosure are described by the dependent claims, the following description, and the figures.

The disclosure provides a battery cell having at least one electrode which has a carrier element and an active layer abutting the carrier element and with an electrode material or active material, the electrode material being provided for the alternating uptake and release of ions and the carrier element electrically connecting the active layer with an electric connecting pole of the battery cell, and the carrier element having an electrically conductive surface for exchanging electrons with the electrode material of the active layer. The carrier element here is understood to mean the flat arrangement that can be implemented in a conventional battery cell by a film, for example a copper film. It is therefore in particular a metallic or metallized carrier layer. The active layer having the electrode material or active material, for example graphite for the negative electrode, may be provided on the carrier element in a known manner The electrode materials of two associated electrodes may be separated through a separator or a separator layer in the known manner.

In the manner described above, such a large current density may result at the electrically conductive surface of the carrier element that the performance of the battery cell may be negatively impacted, for example, due to the interface-resistance. However, the larger the surface area for the passage of electrons between the active layer and the carrier element, the lower the total effective electrical resistance.

In order to provide such a large surface for the electron exchange, so that the electrical resistance between the active layer and the carrier element may become less than a predetermined maximum value, the electrically conductive surface at the respective carrier element is provided by a plurality of electrically conducting elements provided by fibers and/or granules and/or slotted and/or perforated film and/or film strips and/or a wad. In other words, no smooth or flat film is provided as the carrier element, but the surface of the carrier element is structured three-dimensionally, that is to say, it has in particular depressions, e.g., slots or pores, or the free space between fibers. This is to say, provision is made for fibers and/or granules and/or slots/holes in films and/or film strips and/or a wad, whereby said ducts or voids arise in the carrier element, namely in each case spacing or void results between two conducting elements, where further electrode material, and/or other electrically conductive connecting material, for example an electrically conductive paste and/or a powder may be located. The voids can have a diameter of less than 3 millimeters, in particular less than 1 millimeter. That is to say, for example, a flat or rolled sheet or layer may be provided as the carrier element, the surface of which is structured three-dimensionally, so that depressions or voids will form between the individual fibers or generally speaking, between conducting elements as a result. In particular, three-dimensional structuring is understood to mean that one or more, in particular more than 100, depressions at least 10 micrometers deep (in particular more than 20 micrometers deep) are provided in microscopic dimensions in the range from 3 square millimeters to 1 square millimeter. Thereby, the electrically conductive surface of the carrier element is increased, since the voids are delimited by the electrically conductive conducting elements, that is to say, for example, by the surfaces of the electrically conductive fibers.

The disclosure affords the advantage that the outer dimensions of the carrier element (length times width) do not determine the electrically effective surface, but the electrically conductive surface is several times larger than the outer dimension of the carrier element (length times width) because of their three-dimensional structuring due to the use of individual conducting elements, such as, for example, fibers.

The disclosure also includes embodiments through which additional advantages are obtained.

In one embodiment, the fibers and/or film strips are provided as a felt or nonwoven fabric or woven fabric. The conducting elements are thus or intertwined in or with each other or entangled. In doing so, the carrier element has mechanical strength, in particular tensile strength, despite the use of individual conducting elements, such as, for example individual fibers.

In one embodiment, at least some or most of the fibers or film strips are oriented towards the electrode terminal. Orienting the conducting elements towards the electrode terminal results in the advantage that, within the carrier element, the electrons can always be guided within the conducting elements of the carrier element without crossing between two conducting elements, that is to say without having to overcome a limit resistance or interface. This avoids unnecessary additional ohmic resistance. If the conducting elements are too short, the ohmic resistance is at least minimized by the orientation.

In one embodiment, some or all conducting elements themselves are formed from an electrically conductive material. An example of an electrically conductive material that is suitable for providing entire conducting elements, is copper and aluminum. Since the conducting elements themselves are electrically conductive, an electrically conductive cross section in the carrier element is particularly large.

In one embodiment, some or all of the conducting elements in each case are formed by a basic element having an electrically conductive coating and/or jacket. Providing a basic element, such as, for example, a nonwoven fabric or a felt made of woven fabric or glass fibers, and an additional electrically conductive coating or jacket, results in the advantage that by using the basic element (nonwoven fabric made of electrically insulating fibers), at least one texture of the carrier element, such as, for example, fiber density and/or woven fabric form, can be specified regardless of the electrically conductive material of the carrier element, and then, by adding or providing the electrically conductive coating and/or jacket, the electric conductivity can be set or provided separately.

The disclosure also provides a vehicle battery for a motor vehicle. The vehicle battery has at least one battery cell according to the disclosure. Preferably, it is a battery cell made in lithiumion technology. Such a vehicle battery, for example, can be configured as a high volt battery with a nominal voltage (DC voltage) is greater than 60 volts, particularly greater than 100 volts. However, a vehicle battery for a low-voltage vehicle electrical system (electrical voltage less than 60 volts) based on at least one battery cell according to the disclosure can also be provided. Preferably a plurality of battery cells, or all battery cells of the vehicle battery have the inventive features described.

The disclosure also provides a motor vehicle with a vehicle battery according to the disclosure. The motor vehicle according to the disclosure is preferably configured as a motor vehicle, in particular as a passenger car or truck, or as a passenger bus or motorcycle.

The disclosure also provides a method for producing a carrier element for an electrode of a battery cell, wherein the carrier element is formed from a felt or nonwoven fabric or woven fabric or granules made from electrically conductive conducting elements and thereby a void for electrode material and/or an electrically conductive connecting material is left between the conducting elements in each case, the voids being delimited by an electrically conductive surface of the conducting elements. The electrode material of the active layer or another electrically conductive material can thus likewise be introduced into the voids in order to enable a flow of electrons between the active layer and the voids. The method thus provides a carrier element which may be coated with an active layer with electrode material or active material to form an electrode for a battery cell. In this case, the carrier element is not as smooth as a film, but has the described voids on the surface, resulting in the three-dimensionally structured surface. A diameter of such a void is preferably less than 3 millimeters, in particular less than 1 millimeter, in particular less than 100 micrometers. Voids configured as slots can be longer than these values, but their slot width is preferably at the stated values. For forming the felt or nonwoven fabric or woven fabric, for example, so-called nanofibers may be used as the conducting elements, that is to say fibers having a diameter less than 100 micrometers, in particular less than 10 micrometers. Balls may be used as granules, between which also voids form when they are connected to a carrier element. To improve electrical conductivity within a carrier element, provision can be made to electrically connect the individual conducting elements with each other in a firmly bonded manner For this purpose, the conducting elements can be soldered or welded to one another. The individual fibers are therefore preferably firmly bonded to one another. For this purpose, in producing the carrier element, for example, an electric current can be supplied, by means of which the individual conducting elements are heated to such an extent that they fuse or start melting. Additionally or alternatively, the carrier element may also be heated by an external heat source, for example a flame, such that the conducting elements soften or liquefy on their surfaces and firmly bond together. The conducting elements can also be dipped in an electrically conductive, liquid material, resulting in firmly bonding. This is comparable to the process of dip soldering or wave soldering. Vapor deposition of an electrically conductive material on the conducting elements can be provided. Copper or aluminum or tin can be used as the material.

In one embodiment, the conducting elements are generated from a basic element by coating the basic element with an electrically conductive layer. Thus, the shape and/or density and/or size of the voids in the carrier element can first be specified by means of the basic element by using basic elements, for example fibers made of woven fabric or glass fiber or plastic, and then providing the electrical conductivity by coating. It can also be provided first to coat the basic elements, and then to generate the carrier element, for example, by felting or weaving the basic elements.

In one embodiment, the electrically conductive layer is generated by metallizing the basic elements. Metallizing has the advantage that the electrical conductivity of the metal can be used. For metallizing, a method known per se can be utilized, for example, by electroplating or vapor deposition of metal or by sputtering or PVD.

The disclosure also includes further developments of the method according to the disclosure, having the features as already described in connection with the further developments of battery cell according to the disclosure. For this reason, the corresponding further developments of the method according to the disclosure are not described again here. Accordingly, the disclosure also includes further developments of the battery cell according to the disclosure having features as described in connection with the further developments of the method according to the disclosure.

The disclosure also comprises combinations of the features of the embodiments described. That is to say, the disclosure also includes implementations which each have a combination of the features of several of the embodiments described, unless the embodiments have been described as mutually exclusive.

### BRIEF DESCRIPTION OF THE FIGURES

Exemplary embodiments of the disclosure are described below.

FIG. 1 shows a schematic representation of a cross section through an electrode of a battery cell according to the prior art and according to the disclosure, respectively; and

FIG. 2 shows a schematic representation of an embodiment of the motor vehicle according to the disclosure with a vehicle battery according to the disclosure, in which battery cells according to the disclosure are provided.

### DETAILED DESCRIPTION

The embodiments explained below are preferred embodiments of the disclosure. In the exemplary embodiments, the components described of the embodiments each represent individual features of the disclosure to be considered independently of one another, each of which further develops the disclosure independently. Therefore, the disclosure is intended to include combinations of the features of the embodiments other than those shown. Furthermore, the embodiments described can be supplemented by further features of the disclosure of those already described.

In the figures, the same reference numerals denote elements with the same function.

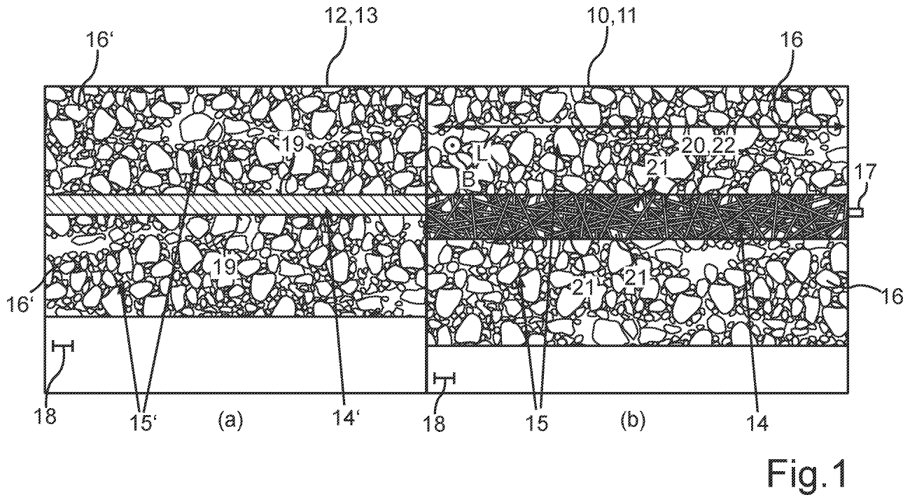

FIG. 1 shows two illustrations, a and b, wherein illustration b of a battery cell 10 illustrates an electrode 11 and, for comparison, illustration a shows one of a battery cell 12, as is known from the prior art, an electrode 13 with the same function as electrode 11.

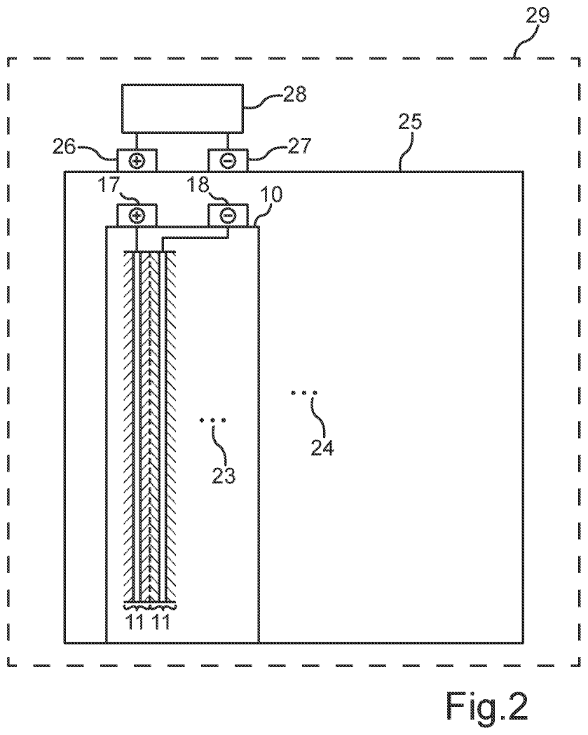

In the case of battery cell 10, electrode 11 may have a carrier or a carrier element 14, on which, on one side or (as illustrated in FIG. 2) on two opposite sides, in each case an active layer 15 with an active material or electrode material 16, such as, for example, graphite, may be arranged. By means of carrier element 14, the respective active layer 15 can be electrically connected to a connection pole 17 (positive pole or negative pole) of battery cell 10.

In illustration a, functionally identical elements have the same reference numerals, but shown with apostrophes. In addition, for both illustration a, b, a scale 18 is shown, which, in this case, may be, for example, in a range of 5 to 20 micrometers, may be, for example, 10 micrometers.

In the case of battery cell 12, its electrode 13 can be a film or a sheet metal as a carrier element 14′. Correspondingly, the smooth or flat surface 19 of the carrier element, the area value of the dimension of carrier element 14′, that is to say length times width.

In the case of battery cell 10, carrier element 14 has, in contrast to carrier element 14′, conducting elements, that is to say electrically conductive elements (conducting elements 20), of which, for the sake of clarity, in FIG. 1 only a few are provided with reference numerals.

Conducting elements 20 can be, for example, metal-coated fibers or pieces of wire. Conducting elements 20 may be intertwined as felt, nonwoven fabric or woven fabric with each other. This results in voids 21 between conducting elements 20, of which, for the sake of clarity, again, only a few are provided with reference numerals. This results in an electrically conductive surface 22 on the surface of the conducting elements that in total is greater than a dimension of carrier element 14, that is, a length L and a width B which is perpendicular to the length L and perpendicular to the plane of FIG. 1. Through this electrically conductive surface 22 electrons can be exchanged between carrier element 14 and the at least one active layer 15 or pass over. This results in a lower electrical ohmic resistance in comparison to surface 19 of carrier element 14′.

FIG. 2 illustrates how electrode 11 or a plurality of such electrodes 11 can be arranged in a battery cell 10. Dots 23 indicate that several of the illustrated layer arrangements of electrodes 11 may be present in battery cell 10. Dots 24 illustrate that a plurality of battery cells 10 can be provided. Battery cells 10 may be provided in a vehicle battery 25 and (not shown) interconnected with battery terminals 26 in a known manner to operate a vehicle electrical system 28. Vehicle battery 25 may be provided in a motor vehicle 29, for example, an electric vehicle or a hybrid vehicle. Vehicle battery 25 can be configured as a high-voltage battery. The battery cell 10 may be based on Lithium-ion technology.

It is therefore proposed to replace the previous metal films made of, e.g., aluminum or copper with a metallized nonwoven fabric or woven fabric. Advantages at comparable capacity are:
performance due to increase of the electrochemically active surface,
increase of the mechanical strength and thus the potential rate of production,
improved adhesion of the active materials (3D nonwoven fabric compared to 2D film).

Conversely, with comparable performance, a higher energy density is possible through thicker electrodes.

A nonwoven fabric or woven fabric may have several layers of nanofibers (comparable to fine-dust air filters) and may be metallized at the surface. Suitable methods for metallization include, e.g., electroplating or evaporating methods such as sputtering or PVD (Physical Vapor Deposition).

In a further method step, the nonwoven fabric can be compressed to a defined thickness in a calender in order to obtain a nonwoven fabric of homogeneous thickness. The downstream processing steps of coating and drying correspond to the previous methods.

Further possible variants are obtained by the following features: the nonwoven fabric or woven fabric may be produced from an electrically conductive, from an electrically non-conductive basic material or a mixture thereof. The nonwoven fabric or woven fabric may consist of metal fibers, which means that the coating process is not required. Depending on the application, metallization can be carried out over the entire surface or partially on the nonwoven fabric. Metallized fibers can be used, alternatively the nonwoven fabric can be metallized afterwards. The nonwoven fabric can contain directional fibers or non-directional fibers depending on the application. The nonwoven fabric may consist of a basic structure or a woven fabric (which enable an improved processing rate) and a support structure (forming the backbone of the galvanic surface).

Overall, the examples show how the performance of battery cells can be provided by increasing the electrical surface of the material of the carrier element.

1. A battery cell comprising: at least one electrode which has a carrier element and an active layer abutting the carrier element and with an electrode material for the alternating uptake and release of ions, the carrier element electrically connecting the active layer with an electric connecting pole of the battery cell, and having an electrically conductive surface for exchanging electrons with the electrode material of the active layer, wherein the electrically conductive surface of the respective carrier element is provided by electrical conducting elements, the conducting elements being provided by fibers and/or granules and/or a slotted and/or perforated film and/or film strip and/or a wad.

2. The battery cell according to claim 1, wherein the fibers and/or film strips are provided as a felt or nonwoven fabric or woven fabric.

3. The battery cell according to claim 1, wherein at least some or most or all of the fibers or film strips are oriented towards the electrode terminal.

4. The battery cell according to claim 1, wherein some or all conducting elements are made of an electrically conductive material.

5. The battery cell according to claim 1, wherein some or all conducting elements are each formed by a basic element having an electrically conductive coating and/or jacket.

6. A battery with at least one battery cell according claim 1.

7. A motor vehicle with a vehicle battery according to claim 6.

8. A method for producing a carrier element for an electrode of a battery cell, wherein the carrier element is formed from a felt or nonwoven fabric or woven fabric or granules made of electrically conductive conducting elements and thereby a void for electrode material and/or an electrically conductive connecting material is left between the conducting elements in each case.

9. The method according to claim 8, wherein the conducting elements each are generated from a basic element by coating the basic element with an electrically conductive layer.

10. The method according to claim 8, wherein the electrically conductive layer is generated by metallizing the basic elements.

11. The battery cell according to claim 2, wherein at least some or most or all of the fibers or film strips are oriented towards the electrode terminal.

12. The battery cell according to claim 2, wherein some or all conducting elements are made of an electrically conductive material.

13. The battery cell according to claim 3, wherein some or all conducting elements are made of an electrically conductive material.

14. The battery cell according to claim 2, wherein some or all conducting elements are each formed by a basic element having an electrically conductive coating and/or jacket.

15. The battery cell according to claim 3, wherein some or all conducting elements are each formed by a basic element having an electrically conductive coating and/or jacket.

16. The battery cell according to claim 4, wherein some or all conducting elements are each formed by a basic element having an electrically conductive coating and/or jacket.

17. The method according to claim 9, wherein the electrically conductive layer is generated by metallizing the basic elements.
